(19) United States
(12) Patent Application Publication
(10) Pub. No.: US 2024/0304948 A1
(43) Pub. Date: Sep. 12, 2024

(54) SECONDARY BATTERY AND METHOD OF MANUFACTURING SECONDARY BATTERY

(71) Applicant: MURATA MANUFACTURING CO., LTD., Kyoto (JP)

(72) Inventor: Yuuki KOBAYASHI, Kyoto (JP)

(21) Appl. No.: 18/413,389

(22) Filed: Jan. 16, 2024

(30) Foreign Application Priority Data
Mar. 7, 2023 (JP) 2023-034490

(51) Int. Cl. H01M 50/46; H01M 10/04

(52) U.S. Cl. CPC H01M 50/461; H01M 10/049

(57) ABSTRACT

A secondary battery is provided and includes a positive electrode, a negative electrode, a separator disposed between the positive electrode and the negative electrode, and an electrolyte. A space between the positive electrode and the separator and a space between the negative electrode and the separator are bonded with an adhesive, and the adhesive has a substantially annular shape when viewed in the stacking direction of the positive electrode, the separator, and the negative electrode.

### CROSS REFERENCE TO RELATED APPLICATIONS

The present application claims priority to Japanese patent application no. 2023-034490, filed on Mar. 7, 2023, the entire contents of which are incorporated herein by reference.

### BACKGROUND

The present application relates to a secondary battery and a method of manufacturing the secondary battery.

A secondary battery having a structure in which a positive electrode and a negative electrode are alternately stacked with a separator interposed therebetween is known. A method of manufacturing such a secondary battery is disclosed and including an adhesion step of adhering a separator to one surface of each of both positive and negative electrodes, and a power generating element forming step of forming a power generating element by stacking or winding each electrode with another electrode via the separator adhered thereto, wherein an adhesive is applied to the electrode to adhere the separator, or an adhesive layer is formed on the electrode and then the separator is adhered.

### SUMMARY

The present application relates to a secondary battery and a method of manufacturing the secondary battery.

When an adhesive is applied to an electrode, it is common to uniformly apply the adhesive to a surface of the electrode. However, when the adhesive is uniformly applied to the surface of the electrode, resistance increases, and battery characteristics may be deteriorated.

The present application relates to providing, in an embodiment, a secondary battery capable of suppressing deterioration of battery characteristics due to an adhesive for bonding an electrode and a separator, and a method of manufacturing such a secondary battery.

A secondary battery of an embodiment includes:
a positive electrode;
a negative electrode;
a separator disposed between the positive electrode and the negative electrode; and
an electrolyte,
in which a space between the positive electrode and the separator and a space between the negative electrode and the separator are bonded with an adhesive, and the adhesive has a substantially annular shape when viewed in a stacking direction of the positive electrode, the separator, and the negative electrode.

A method of manufacturing a secondary battery according to an embodiment includes:
spraying a suspension containing an adhesive to at least one of a positive electrode and a separator;
spraying the suspension to at least one of a negative electrode and the separator;
evaporating a liquid contained in the sprayed suspension; and
producing a laminate by stacking the positive electrode, the separator, and the negative electrode in a mode in which the separator is interposed between the positive electrode and the negative electrode after the step of evaporating the liquid.

According to the secondary battery, the space between the positive electrode and the separator and the space between the negative electrode and the separator are bonded with an adhesive, and the adhesive has a substantially annular shape when viewed in the stacking direction of the positive electrode, the separator, and the negative electrode. Therefore, since a central portion of the substantially annular adhesive has no or a small amount of the adhesive, resistance can be reduced as compared with a configuration in which the adhesive is uniformly applied, and deterioration of battery characteristics due to the presence of the adhesive can be suppressed.

According to the method of manufacturing a secondary battery, it is possible to produce a stacked body in which the space between the positive electrode and the separator and the space between the negative electrode and the separator are bonded with an adhesive having a substantially annular shape. Since a central portion of the substantially annular adhesive has no or a small amount of the adhesive, resistance is lower than that of a configuration in which the adhesive is uniformly applied, and it is possible to manufacture a secondary battery in which deterioration of battery characteristics due to the presence of the adhesive is suppressed.

### BRIEF DESCRIPTION OF THE FIGURES

FIG. 1 is a schematic sectional view illustrating the configuration of a secondary battery according to an embodiment of the present disclosure;

FIG. 2 is a schematic plan view illustrating an example of a shape of an adhesive;

FIG. 3 is a view obtained by observing a section of the adhesive illustrated in FIG. 2 taken along line III-III with a microscope;

FIG. 4(a) is a schematic plan view illustrating an example of another shape of the adhesive, and FIGS. 4(b) and 4(c) are schematic plan views illustrating an example of still another shape of the adhesive;

FIG. 5(a) is an image when the adhesive applied to a positive electrode is observed with a microscope, FIG. 5(b) is an image when the adhesive applied to a negative electrode is observed with the microscope, FIG. 5(c) illustrates an image in which the adhesive is detected by image processing from the image illustrated in FIG. 5(a), and FIG. 5(d) illustrates an image in which the adhesive is detected by image processing from the image illustrated in FIG. 5(b);

FIGS. 6(a) to 6(d) are views for explaining a mechanism in which the shape of the adhesive is substantially annular;

FIG. 7 is a view for explaining a method of measuring a coverage of the adhesive to the positive electrode;

FIG. 8 is a view illustrating a relationship between a distance in a longitudinal direction from a center point of the positive electrode and the coverage of the adhesive, and a relationship between a distance in the longitudinal direction from a center point of the negative electrode and the coverage of the adhesive;

FIG. 9 is a view illustrating a numerical distribution of diameters of the adhesive;

FIG. 10 is a flowchart for explaining an example of a method of manufacturing a secondary battery;

FIGS. 11(a) to 11(c) are views for explaining a method of measuring peel strength of the adhesive;

FIG. 12 is a view illustrating a relationship between the coverage of the adhesive and the peel strength when the separator is peeled off from the electrode;

FIG. 13 is an exploded view of a coin cell prepared for examining a relationship between the coverage of the adhesive and the capacity retention ratio of the battery;

FIG. 14 is a view illustrating a relationship between the coverage of the adhesive to the positive electrode and a discharge capacity retention ratio of the coin cell; and

FIG. 15 is a view illustrating a relationship between the coverage of the adhesive to the negative electrode and the discharge capacity retention ratio of the coin cell.

### DETAILED DESCRIPTION

The present application will described below in further detail including with reference to the figures according to an embodiment.

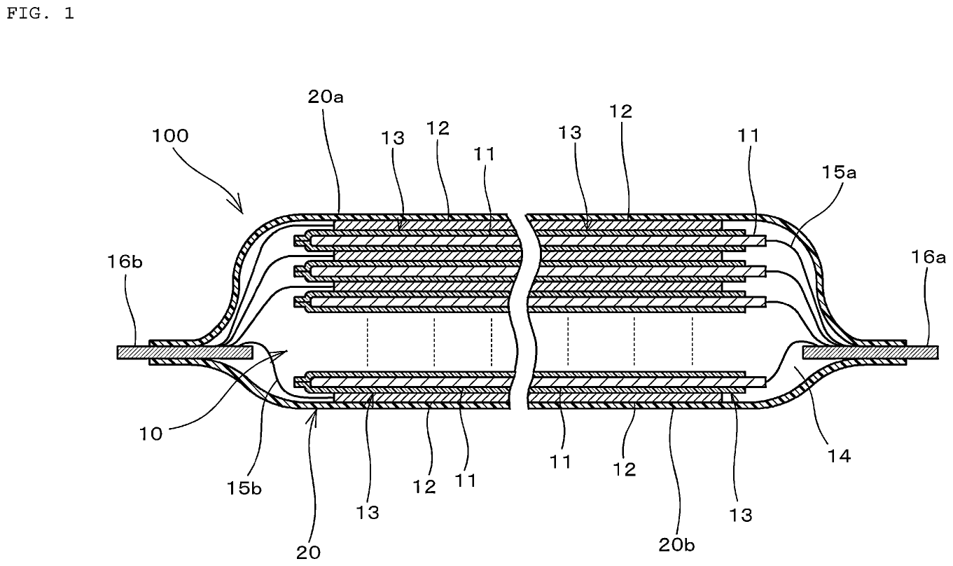

FIG. 1 is a schematic sectional view illustrating the configuration of a secondary battery 100 according to an embodiment. In this embodiment, a case where the secondary battery 100 is a lithium-ion secondary battery will be described. However, the secondary battery 100 is not limited to the lithium-ion secondary battery.

The secondary battery 100 includes a positive electrode 11, a negative electrode 12, a separator 13, and an electrolyte 14.

The positive electrode 11 has a positive electrode active material capable of storing and releasing lithium ions. More specifically, the positive electrode 11 has a positive electrode mixture layer containing the positive electrode active material, and a positive electrode current collector. The positive electrode mixture layer is provided on at least one surface of the positive electrode current collector. The positive electrode mixture layer may be provided on both surfaces of the positive electrode current collector, or may be provided only on one surface thereof. The positive electrode current collector is, for example, a metal foil such as aluminum.

The positive electrode active material is not particularly limited as long as it is a material contributing to insertion and extraction of lithium ions, and for example, the positive electrode active material is preferably a lithium-containing composite oxide. The lithium-containing composite oxide is usually a lithium transition metal composite oxide. The transition metal may be any transition metal (transition element), and examples thereof include a first transition element, a second transition element, and a third transition element. A preferred transition metal is the first transition element. The positive electrode mixture layer may contain a conductive auxiliary agent and a binder in addition to the positive electrode active material.

The negative electrode 12 has a negative electrode active material capable of storing and releasing lithium ions. More specifically, the negative electrode 12 has a negative electrode mixture layer containing the negative electrode active material, and a negative electrode current collector. The negative electrode mixture layer is provided on at least one surface of the negative electrode current collector. The negative electrode mixture layer may be provided on both surfaces of the negative electrode current collector, or may be provided only on one surface thereof. The negative electrode current collector is, for example, a metal foil composed of copper or the like.

The negative electrode active material is not particularly limited as long as it contributes to storage and release of lithium ions, and is preferably a carbon material of various kinds, an oxide, a lithium alloy, silicon, a silicon alloy, or a tin alloy, for example. The negative electrode mixture layer may contain a conductive auxiliary agent and a binder in addition to the negative electrode active material.

The separator 13 is disposed between the positive electrode 11 and the negative electrode 12. The type of the separator 13 is not particularly limited as long as the separator can pass ions while preventing electrical contact between the positive electrode 11 and the negative electrode 12. Although the separator 13 shown in FIG. 1 has a bag-like shape, it may have a sheet shape or may have a zigzag folded shape.

The material constituting the separator 13 is not particularly limited as long as the electrical contact between the positive electrode 11 and the negative electrode 12 can be prevented, and examples thereof include an electrically insulating polymer. Examples of the electrically insulating polymer include polyolefin, polyester, polyimide, polyamide, and polyamideimide.

The secondary battery 100 in the present embodiment has a structure in which a stacked body 10 formed by alternately stacking a plurality of the positive electrodes 11 and a plurality of the negative electrodes 12 with the separator 13 interposed therebetween and the electrolyte 14 are housed in a laminate case 20. The laminate case 20, which is an exterior body, is formed by joining peripheral portions of a pair of laminate films 20a and 20b by thermal compression bonding. However, the exterior body accommodating the stacked body 10 is not limited to the laminate case 20.

The electrolyte 14 assists movement of lithium ions released from the electrodes (positive electrode/negative electrode). The electrolyte is, for example, a nonaqueous electrolyte, and includes a nonaqueous solvent and an electrolyte salt. The nonaqueous electrolyte may have a form such as liquid or gel. The electrolyte 14 is, for example, a nonaqueous electrolytic solution.

A positive electrode terminal 16a is led to the outside from one end side of the laminate case 20, and a negative electrode terminal 16b is led to the outside from the other end side. The plurality of positive electrodes 11 are connected to the positive electrode terminal 16a through lead wires 15a. The plurality of negative electrodes 12 are connected to the negative electrode terminal 16b through lead wires 15b.

A space between the positive electrode 11 and the separator 13 and a space between the negative electrode 12 and the separator 13 are bonded with an adhesive. The adhesive has a substantially annular shape when viewed in a stacking direction of the positive electrode 11, the separator 13, and the negative electrode 12.

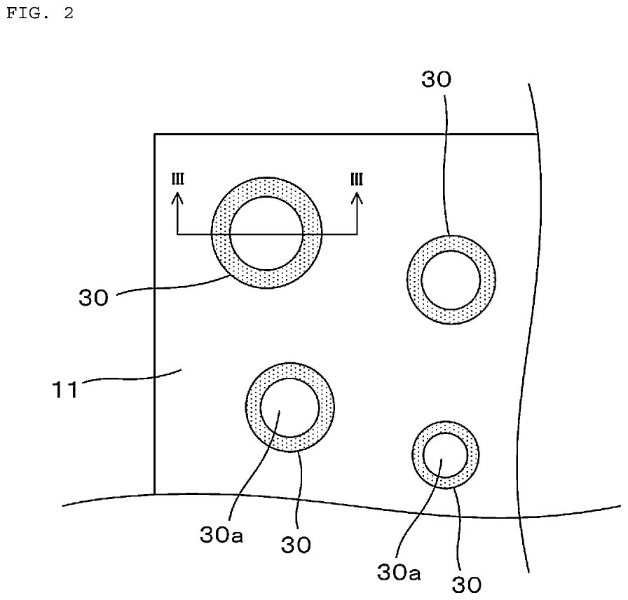

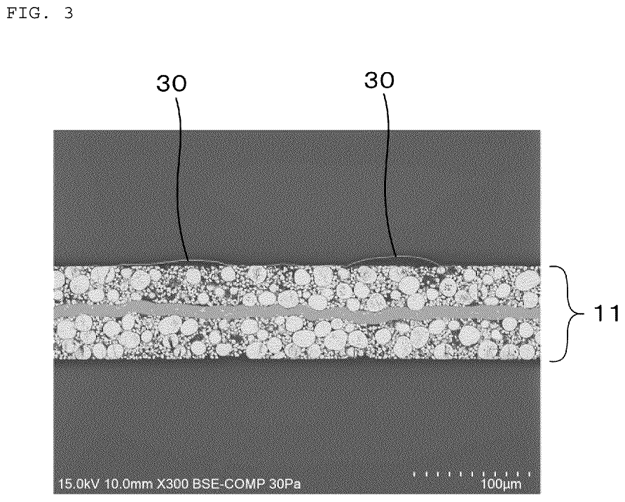

FIG. 2 is a schematic plan view illustrating an example of a shape of an adhesive 30. FIG. 2 illustrates the adhesive 30 applied to the positive electrode 11, and the same applies to the adhesive 30 applied to the negative electrode 12. FIG. 3 is a view obtained by observing a section of the adhesive 30 illustrated in FIG. 2 taken along line III-III with a scanning electron microscope. In order to improve visibility, a surface of the adhesive 30 illustrated in FIG. 3 is coated with Au.

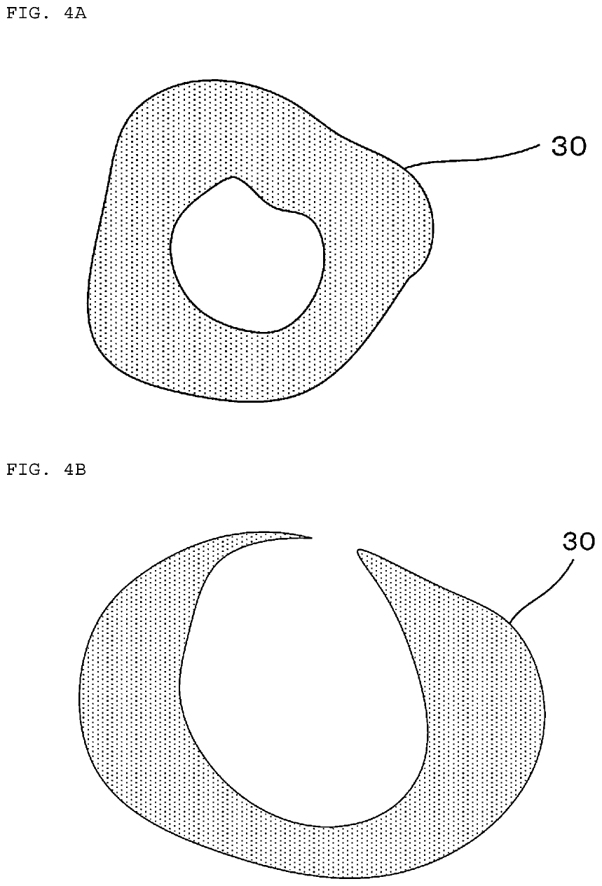

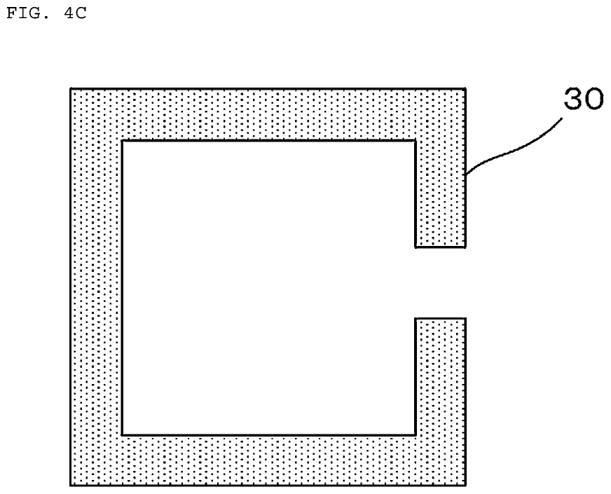

In the example illustrated in FIG. 2, the adhesive 30 has an annular shape when viewed in the stacking direction. In FIG. 2, the outer periphery and inner periphery of the annular adhesive 30 each have a circular shape; however, the shape of the outer periphery is not limited to a circular shape, and the shape of the inner periphery is not limited to a circular shape. Although the adhesive 30 illustrated in FIG. 2 has a constant width in a radial direction, the width may not be constant like the adhesive 30 illustrated in FIG. 4(a).

In an inner region 30a of the substantially annular adhesive 30, the adhesive 30 does not exist, or has a smaller amount of adhesive 30 than the region of the substantially annular adhesive 30. Thus, the inner region 30a of the substantially annular adhesive 30 has higher ionic conductivity than a region coated with the adhesive 30. Therefore, in the secondary battery 100 in the present embodiment, resistance can be reduced as compared with a conventional configuration in which the adhesive is uniformly applied, and deterioration of battery characteristics due to the presence of the adhesive 30 can be suppressed.

All of a plurality of the adhesives 30 existing between the positive electrode 11 and the separator 13 and between the negative electrode 12 and the separator 13 do not need to have an annular shape, and some of the adhesives may have a substantially annular shape. For example, among the plurality of adhesives 30 existing between the positive electrode 11 and the separator 13 and between the negative electrode 12 and the separator 13, as shown in FIGS. 4(b) and 4(c), the adhesive 30 having a shape that is not connected in a direction along the outer periphery and is discontinuous may be included. That is, the “substantially annular” shape includes not only an annular shape connected in the direction along the outer periphery but also the shape that is not connected in the direction along the outer periphery and is discontinuous.

The adhesive 30 is not dissolved in the electrolyte 14, and is, for example, an acrylic resin. However, the adhesive 30 is not limited to the acrylic resin, and may be SBR (styrene butadiene rubber) or the like. Since the adhesive 30 is not dissolved in the electrolyte 14, adhesiveness between the positive electrode 11 and the separator 13 and adhesiveness between the negative electrode 12 and the separator 13 can be maintained. The solid content concentration of the adhesive 30 is, for example, 14.0 wt % or more and 16.0 wt % or less, and the viscosity is, for example, 1 mPa·s or more and 10 mPa·s or less. The pH of the adhesive 30 is, for example, 6.5 or more and 8.5 or less.

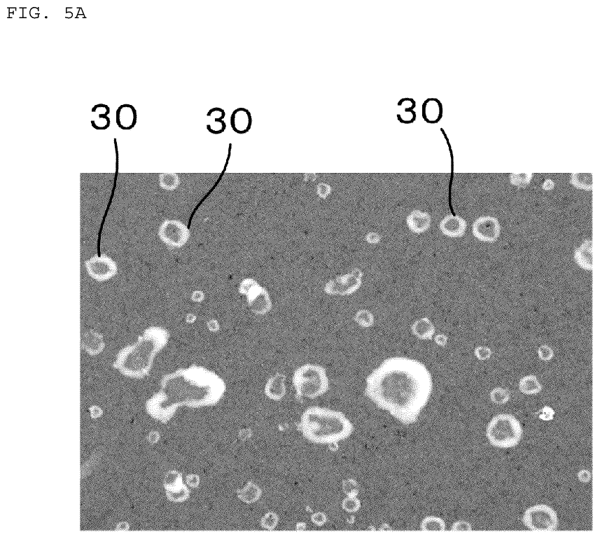

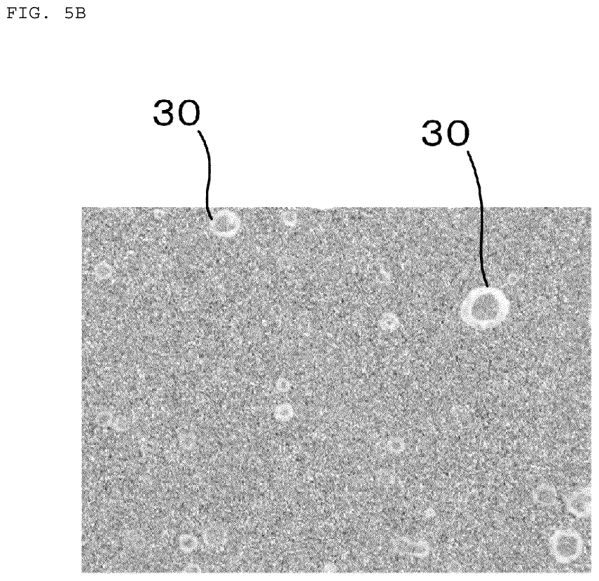

FIG. 5(a) is an image when the adhesive 30 applied onto the positive electrode 11 is observed with a microscope (VHX-500, manufactured by KEYENCE CORPORATION), and FIG. 5(b) is an image when the adhesive 30 applied onto the negative electrode 12 is observed with a microscope FIG. 5(c) illustrates an image in which the adhesive 30 is detected by image processing from the image illustrated in FIG. 5(a), and FIG. 5(d) illustrates an image in which the adhesive 30 is detected by image processing from the image illustrated in FIG. 5(b). As illustrated in FIGS. 5(a) to 5(d), the plurality of adhesives 30 having a substantially annular shape exist between the positive electrode 11 and the separator 13 and between the negative electrode 12 and the separator 13, respectively. Since the plurality of adhesives 30 having a substantially annular shape exist between the positive electrode 11 and the separator 13 and between the negative electrode 12 and the separator 13, respectively, adhesion between the positive electrode 11 and the separator 13 and between the negative electrode 12 and the separator 13 can be further improved, and the battery characteristics can be further improved.

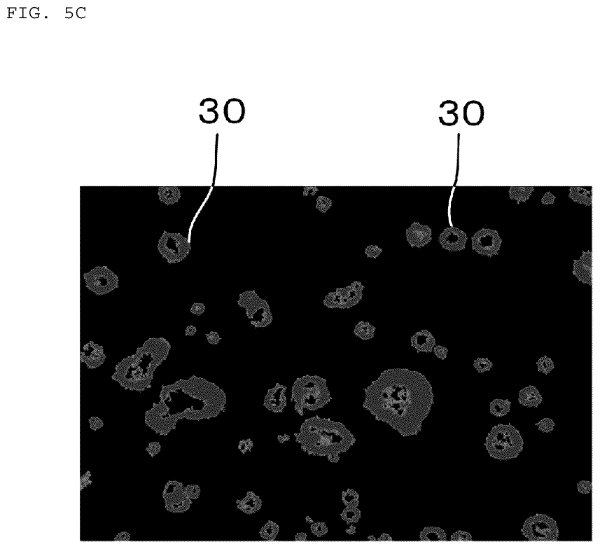

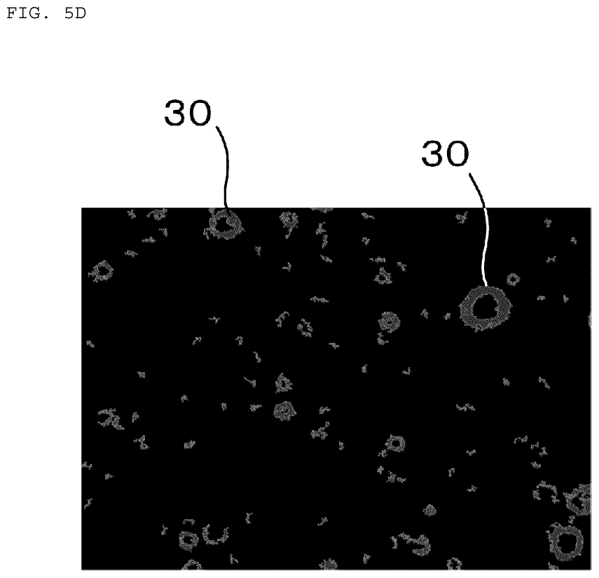

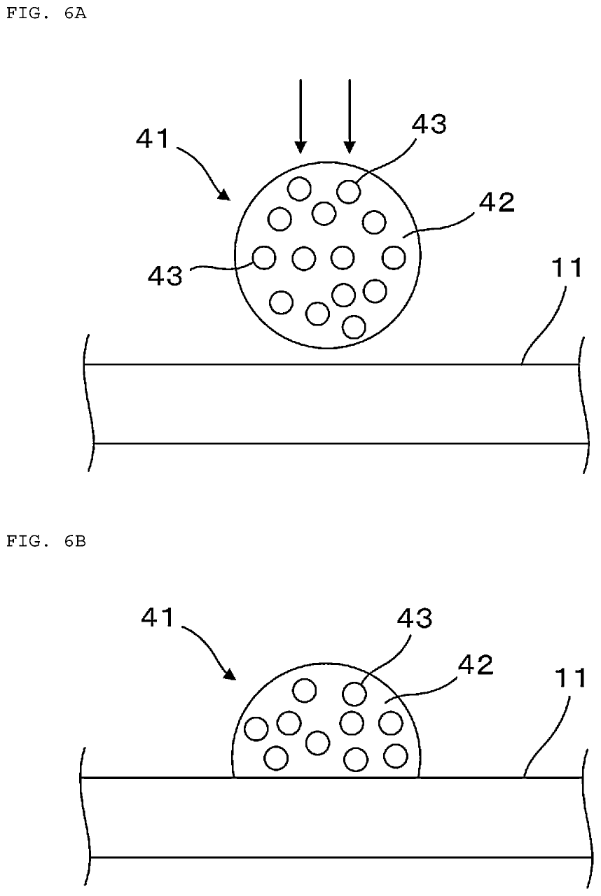

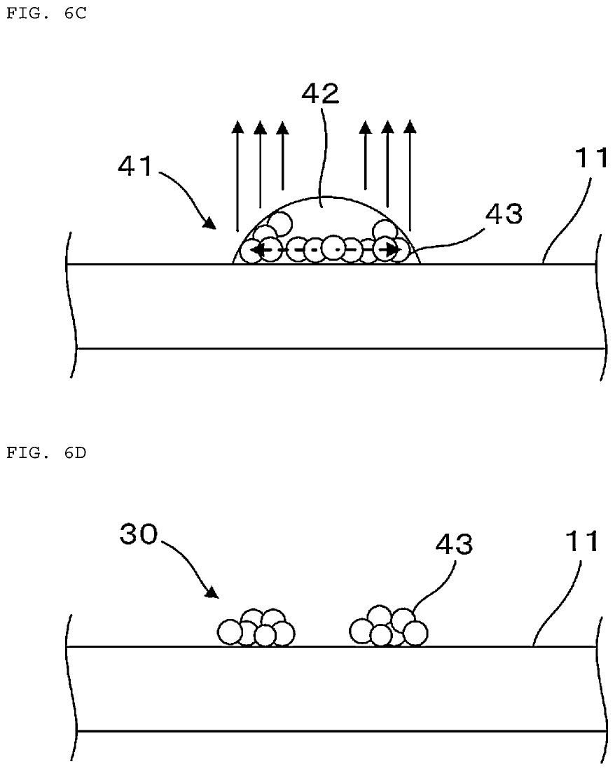

Here, a mechanism in which the shape of the adhesive 30 interposed between the positive electrode 11 and the separator 13 and between the negative electrode 12 and the separator 13 is substantially annular will be described. Here, with reference to FIG. 6, description will be made on the assumption that the adhesive 30 is applied to the positive electrode 11.

First, as illustrated in FIG. 6(a), a suspension 41 containing the adhesive is sprayed to the positive electrode 11. In the suspension 41, solid particles 43 of the adhesive are dispersed in a liquid 42. The liquid 42 is, for example, water, and the adhesive is, for example, an acrylic resin. However, the adhesive is not limited to the acrylic resin, and may be SBR (styrene butadiene rubber) or the like. The solid content concentration of the suspension 41 is, for example, 3 wt % or more and 15 wt % or less, and the viscosity is 1 mPa·s or more and 10 mPa·s or less. A particle size (D50) of the solid particles 43 of the adhesive is, for example, 250 nm or more and 650 nm or less.

The method of spraying the suspension 41 is not particularly limited, and for example, it can be performed by a method such as ultrasonic spraying, two-fluid spraying, or inkjet spraying. In the two-fluid spraying, for example, two fluids of the suspension 41 containing the adhesive and air are jetted. The sprayed suspension 41 adheres as droplets to the positive electrode 11 as illustrated in FIG. 6(b).

Subsequently, as illustrated in FIG. 6(c), the liquid 42 contained in the sprayed suspension 41 is evaporated. The evaporation of the liquid 42 can be performed by any method such as heating, natural drying, and drying under reduced pressure. At this time, since the evaporation proceeds in an edge portion located outside a central portion of the liquid 42 than in the central portion, a flow of the fluid from the central portion toward the edge portion is generated as indicated by a broken line arrow in FIG. 6(c). As a result, the solid particles 43 of the adhesive dispersed in the liquid 42 also move to the edge portion.

As the liquid 42 contained in the suspension 41 evaporates, only the solid particles 43 of the adhesive remain on the positive electrode 11 (see FIG. 6(d)). As described above, in the process of evaporation of the liquid 42 contained in the suspension 41, the solid particles 43 of the adhesive move to the edge portion, so that the shape of the adhesive 30 becomes substantially annular.

The same applies to the case of applying the adhesive 30 to the negative electrode 12 and the case of applying the adhesive 30 to the separator 13.

Here, a coverage of the adhesive 30 to the positive electrode 11 and a coverage of the adhesive 30 to the negative electrode 12 were examined. The coverage of the adhesive 30 to the positive electrode 11 means a ratio of a region covered with the adhesive 30 in the surface of the positive electrode 11 to which the adhesive 30 is applied. The coverage of the adhesive 30 to the negative electrode 12 means a ratio of a region covered with the adhesive 30 in the surface of the negative electrode 12 to which the adhesive 30 is applied.

In this case, a relationship between a distance in a longitudinal direction from a center point of the positive electrode 11 and the coverage of the adhesive 30 to the positive electrode 11, and a relationship between a distance in the longitudinal direction from a center point of the negative electrode 12 and the coverage of the adhesive 30 to the negative electrode 12 were examined. A method of measuring the coverage of the adhesive 30 to the positive electrode 11 will be described with reference to FIG. 7.

In FIG. 7, the longitudinal direction of the rectangular positive electrode 11 is an X-axis direction, and the lateral direction is a Y-axis direction. Here, the description will be made assuming that a dimension in the longitudinal direction of the positive electrode 11 is 120 mm and a dimension in the lateral direction is 100 mm.

In this case, as illustrated in FIG. 7, a plurality of measurement areas 50 are set at intervals of 5 mm in the longitudinal direction from the center point of the positive electrode 11, and the plurality of measurement areas 50 are set such that a total of five measurement areas 50 are set at equal intervals in the lateral direction at the same position in the longitudinal direction. The measurement area 50 has a dimension of 1.52 mm in the X-axis direction and a dimension of 1.14 mm in the Y-axis direction.

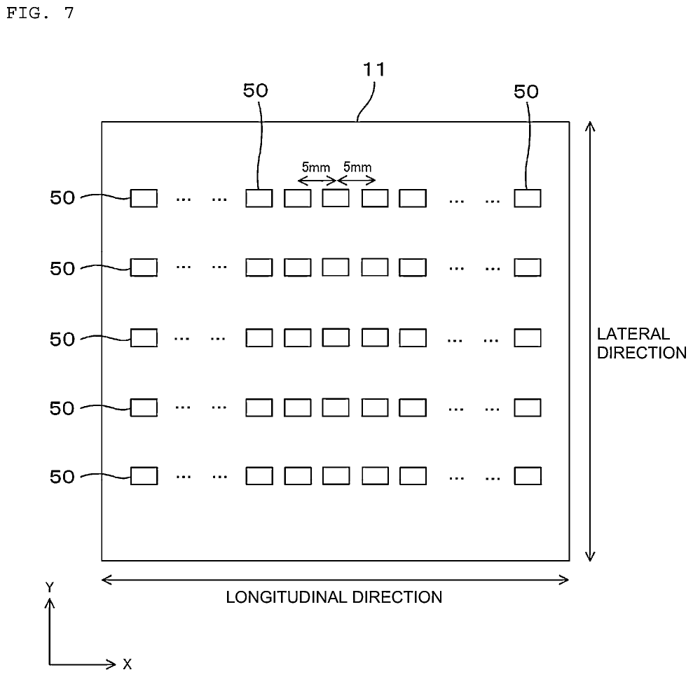

Each of the set measurement areas 50 was observed with a microscope (VHX-500, manufactured by KEYENCE CORPORATION), and image processing was performed from the obtained image to measure the coverage of the adhesive 30. That is, a ratio of an area of the region coated with the adhesive 30 to the area of the measurement area 50 was defined as the coverage of the measurement area 50. Then, an average value of the coverages measured in the five measurement areas 50 at the same position in the longitudinal direction was taken as the coverage at each position in the longitudinal direction. Also for the negative electrode 12, the coverage at each position in the longitudinal direction was measured in the same manner. The coverage at each position in the longitudinal direction of the positive electrode 11 and the negative electrode 12 is illustrated in FIG. 8. In FIG. 8, with the center point of the positive electrode 11 in FIG. 7 as a reference of the X axis, a distance in a positive direction is shown as plus, and a distance in a negative direction is shown as minus. The same applies to the negative electrode 12.

As illustrated in FIG. 8, in both the positive electrode 11 and the negative electrode 12, the coverage of the adhesive 30 varies depending on the position, and the coverage at the end portion tends to be lower than that at a central portion. This is considered to be because the adhesive 30 is applied by spraying as described above.

In the present specification, the coverage measured when the distance in the longitudinal direction from the center point of the positive electrode 11 is within ±25% of the dimension in the longitudinal direction of the positive electrode 11 is defined as “the coverage of the adhesive 30 to the positive electrode 11”. In the example illustrated in FIG. 7, since the dimension in the longitudinal direction of the positive electrode 11 is 120 mm, the coverage measured when the distance in the longitudinal direction from the center point of the positive electrode 11 is in a range of −30 mm or more and 30 mm or less is the “coverage of the adhesive 30 to the positive electrode 11”. Similarly, the coverage measured when the distance in the longitudinal direction from the center point of the negative electrode 12 is within ±25% of the dimension in the longitudinal direction of the negative electrode 12 is defined as “the coverage of the adhesive 30 to the negative electrode 12”.

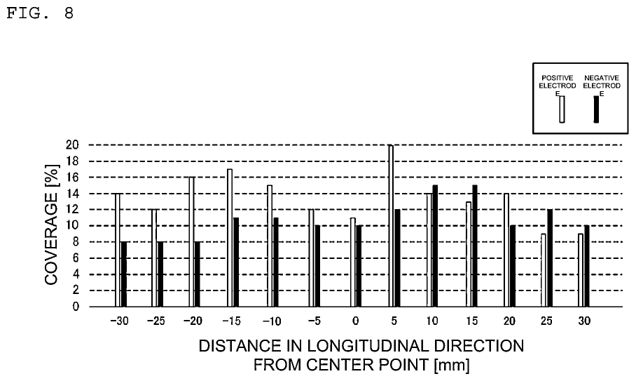

In addition, an equivalent circle diameter of an outer shape of the adhesive 30 was obtained by calculating a circle having the same area as that of the adhesive 30 by image processing, and a number distribution thereof was confirmed. FIG. 9 illustrates the number distribution of the equivalent circle diameters of the adhesive 30. As illustrated in FIG. 9, the proportion of the adhesive 30 having an equivalent circle diameter of more than 30 μm and 60 μm or less is the largest. Although there is also the adhesive 30 having an equivalent circle diameter exceeding 120 μm, the proportion of the adhesive 30 having an equivalent circle diameter of 150 μm or less is 99%, and very few adhesives have an equivalent circle diameter exceeding 150 μm. The equivalent circle diameter of the adhesive 30 is preferably 200 μm or less.

In addition, when the equivalent circle diameter of an inner shape of the adhesive 30 was calculated by the same method, the equivalent circle diameter was often 15 μm or more and 40 μm or less, and was about 70 μm in some cases.

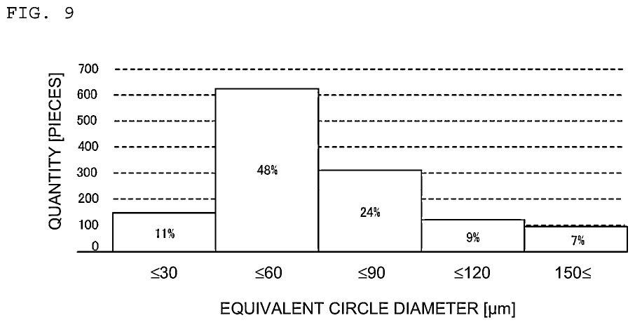

FIG. 10 is a flowchart for explaining an example of a method of manufacturing the secondary battery 100. In step S1, a suspension containing an adhesive is sprayed to at least one of the positive electrode 11 and the separator 13. The suspension is, for example, one in which an acrylic resin as an adhesive is dispersed in water. As an example, the positive electrode 11 is sprayed with the suspension. As described above, the method of spraying the suspension is not particularly limited, and for example, it can be performed by a method such as ultrasonic spraying, two-fluid spraying, or inkjet spraying.

In step S2 following step S1, the suspension containing the adhesive is sprayed to at least one of the negative electrode 12 and the separator 13. As the adhesive and the suspension containing the adhesive, the same one as that used in the process of step S1 can be used. As the method of spraying the suspension, it is possible to adopt the same method as the method of spraying the suspension in the process of step S1. As an example, the negative electrode 12 is sprayed with the suspension.

The process of step S1 may be performed after the process of step S2 is performed, or the process of step S1 and the process of step S2 may be performed simultaneously.

In step S3 following step S2, the liquid contained in the sprayed suspension is evaporated. The evaporation of the liquid can be performed by any method such as heating, natural drying, and drying under reduced pressure. As described above, by evaporating the liquid contained in the suspension, the shape of the adhesive 30 becomes substantially annular.

In step S4 following step S3, after the liquid contained in the suspension is evaporated, the positive electrode 11, the separator 13, and the negative electrode 12 are stacked such that the separator 13 is interposed between the positive electrode 11 and the negative electrode 12, thereby producing the stacked body 10. For example, the plurality of positive electrodes 11, the plurality of separators 13, and the plurality of negative electrodes 12 are stacked in the order of the positive electrode 11, the separator 13, the negative electrode 12, and the separator 13. The number of the positive electrodes 11, the negative electrodes 12, and the separators 13 to be stacked may be any number. After the positive electrode 11, the separator 13, and the negative electrode 12 are stacked, the stacked body 10 may be produced by pressure bonding. The pressure bonding can be performed by any method, and is performed by, for example, heat pressing.

By performing the pressure bonding, the positive electrode 11 and the separator 13 abut against a region where the adhesive 30 is not applied in a region between the positive electrode 11 and the separator 13. On the other hand, in the region coated with the adhesive 30, the adhesive 30 exists between the positive electrode 11 and the separator 13; however, the separator 13 is slightly crushed in the stacking direction by pressure bonding. As a result, a distance between a principal surface of the positive electrode 11 coated with the adhesive 30 and a principal surface of the separator 13 on the side not facing the positive electrode 11 is the same in the region not coated with the adhesive 30 and the region coated with the adhesive 30. The same applies to the relationship between the negative electrode 12 and the separator 13.

In step S5 following step S4, the stacked body is accommodated in the exterior body.

In step S6 following step S5, the inside of the exterior body is filled with the electrolyte 14. The electrolyte 14 is, for example, a nonaqueous electrolytic solution.

By the above-described steps, the secondary battery 100 is obtained.

Here, a relationship between the coverage of the adhesive 30 and peeling strength, and a relationship between the coverage of the adhesive 30 and a capacity retention ratio of the secondary battery 100 were examined.

The coverage and the peeling strength of the adhesive 30 were measured by the method described below.

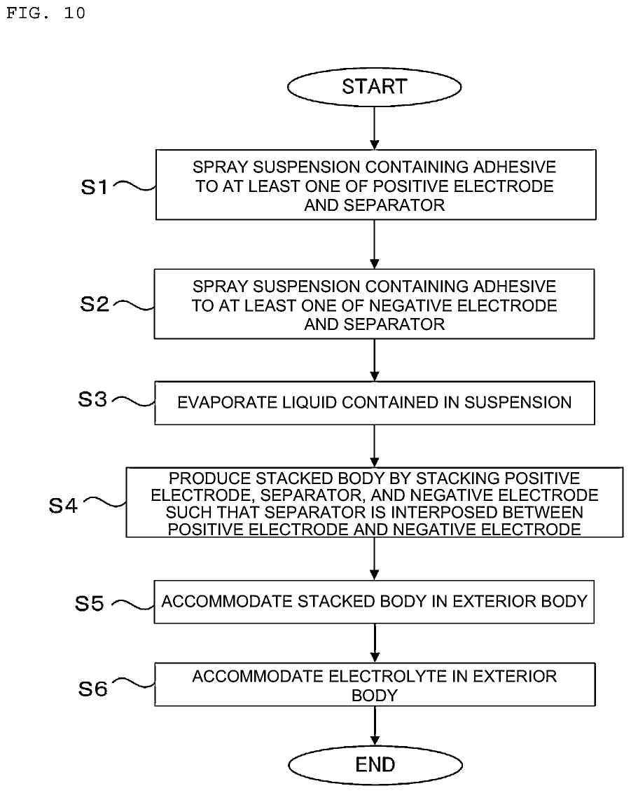

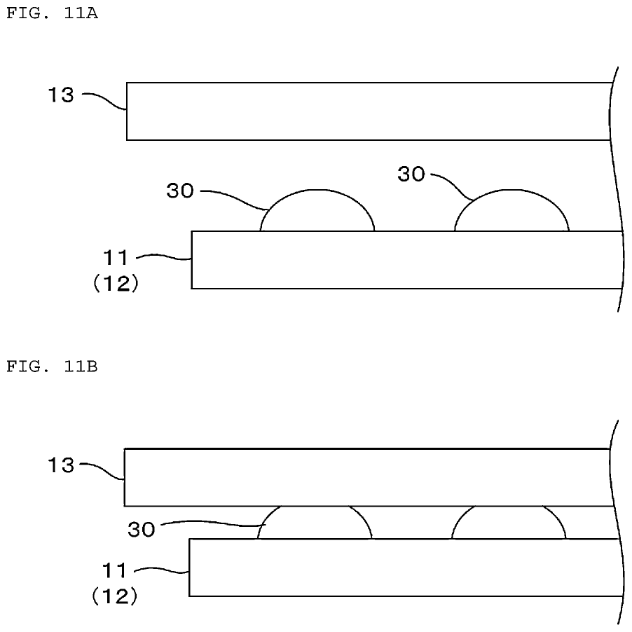

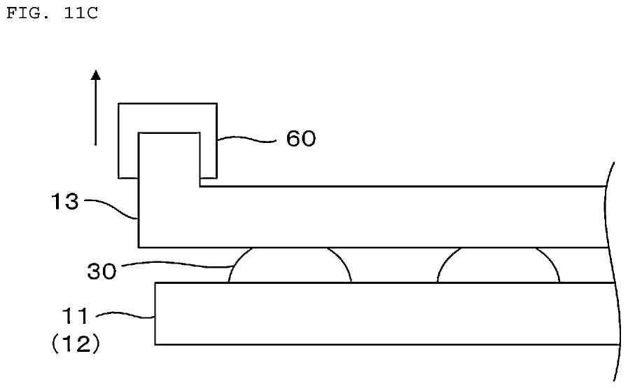

First, as illustrated in FIG. 11(a), the adhesive 30 was applied onto the electrode. The electrode was the positive electrode 11 or the negative electrode 12, and a Cu foil was used here. The adhesive 30 was applied by the method described above. Specifically, a suspension containing the adhesive 30 was sprayed to the electrode by ultrasonic spraying, and the liquid contained in the suspension was evaporated.

After the application of the adhesive 30, the coverage of the adhesive 30 to the electrode was examined.

Subsequently, as illustrated in FIG. 11(b), the electrode and the separator 13 were stacked and pressure-bonded such that the adhesive 30 was interposed between the electrode and the separator 13. In this case, the electrode and the separator 13 were pressure-bonded by heat pressing under the conditions of 60° C., 0.1 seconds, and 6 MPa.

Subsequently, as illustrated in FIG. 11(c), the separator 13 was subjected to a 90° tensile test by a clamp device 60 of a peeling device (P90-200N, manufactured by IMADA Co., Ltd.). In this case, the length of a sample of the separator 13 used was 100 mm, and the length of the Cu foil was 60 mm. A tip portion of the separator 13 having a length of 40 mm, which did not overlap the Cu foil, was gripped by the clamp device 60 and moved at a speed of 50 mm/min to apply a peeling force to the separator 13, and the strength of peeling of the separator 13 from the Cu foil was measured. More specifically, an average value in a range excluding 10 mm at both ends of the Cu foil was measured with a force gauge (ITA-2N, manufactured by IMADA Co., Ltd.) under the condition of a sampling period of 0.1 S.

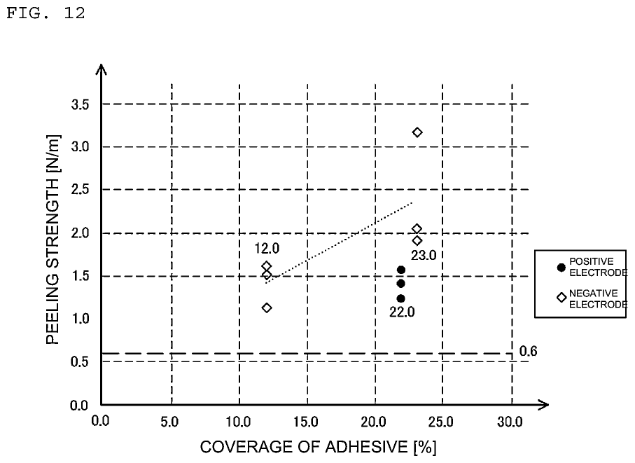

FIG. 12 is a view illustrating the relationship between the coverage of the adhesive 30 examined by the method described above and the peeling strength. Although it was confirmed that there was no problem as a product of the secondary battery 100 when the peeling strength of the separator 13 to the electrode was 0.6 N/m or more, when the coverage of the adhesive 30 to the positive electrode 11 was 22%, the peeling strength was higher than 0.6 N/m. When the coverage of the adhesive 30 to the negative electrode 12 was 12% and 23%, the peeling strength was higher than 0.6 N/m.

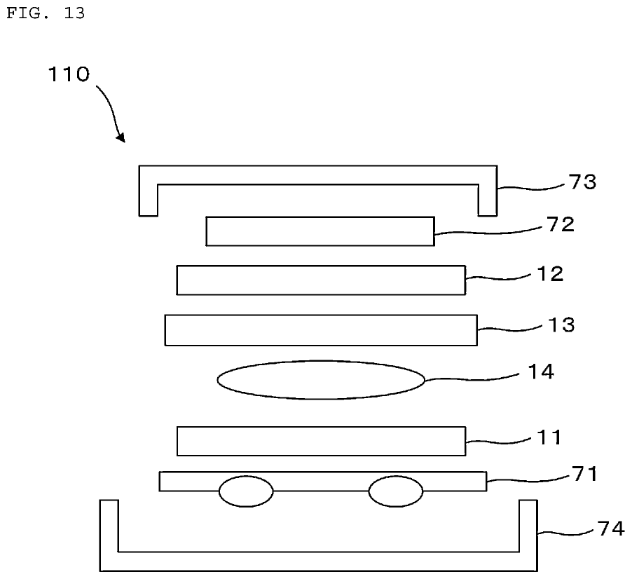

The relationship between the coverage of the adhesive 30 and the capacity retention ratio of the secondary battery 100 was confirmed by preparing a coin cell. FIG. 13 is an exploded view of a coin cell 110 prepared. The coin cell 110 includes the positive electrode 11, the negative electrode 12, the separator 13, the electrolyte 14, a first spacer 71, a second spacer 72, an anode cup 73, and a can 74. The separator 13 is disposed between the positive electrode 11 and the negative electrode 12. The space between the positive electrode 11 and the separator 13 and the space between the negative electrode 12 and the separator 13 are bonded with a plurality of adhesives having a substantially annular shape. The first spacer 71 is disposed between the positive electrode 11 and the can 74, and the second spacer 72 is disposed between the negative electrode 12 and the anode cup 73. The first spacer 71 and the second spacer 72 are insulators. The anode cup 73 functions as a positive electrode terminal, and the can 74 functions as a negative electrode terminal. Although not illustrated in FIG. 13, a gasket is disposed between the anode cup 73 and the can 74 to ensure insulation.

As the positive electrode 11 of the coin cell 110, a rectangular positive electrode from which a center portion was cut off was used. Specifically, a rectangular positive electrode as illustrated in FIG. 7 was prepared, and a region where a distance from the center point in the longitudinal direction was within a range of ±25% of the dimension of the rectangular positive electrode in the longitudinal direction was cut off, and used as the positive electrode 11 of the coin cell 110. The same applies to the negative electrode 12 of the coin cell 110. Thus, in the coin cell 110, the ratio of the region covered with the adhesive 30 on the surface of the positive electrode 11 to which the adhesive 30 is applied directly becomes the “coverage of the adhesive 30 to the positive electrode 11”. Similarly, the ratio of the region covered with the adhesive 30 on the surface of the negative electrode 12 to which the adhesive 30 is applied directly becomes “the coverage of the adhesive 30 to the negative electrode 12”.

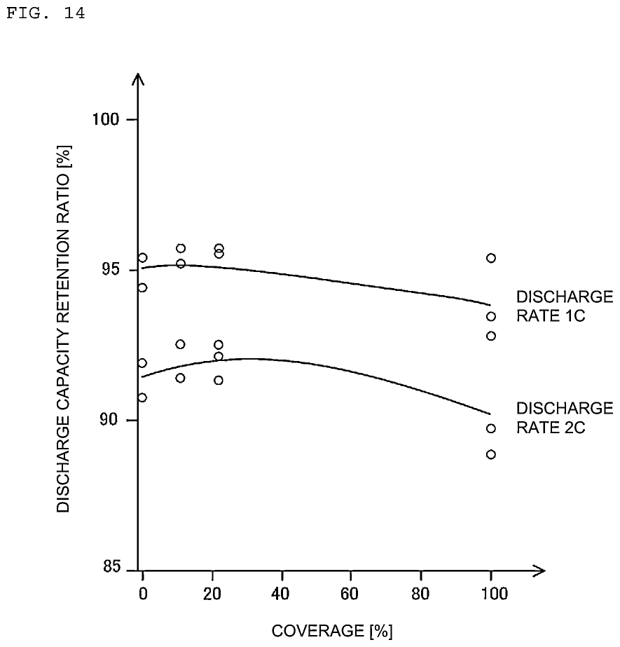

FIG. 14 is a view illustrating a relationship between the coverage of the adhesive 30 to the positive electrode 11 and a discharge capacity retention ratio of the coin cell 110. In this case, the coin cell 110 was discharged at a discharge rate of 1 C and 2 C, and the relationship between the coverage of the adhesive 30 to the positive electrode 11 and the discharge capacity retention ratio of the coin cell 110 was examined. For each of the coin cells 110 having different discharge rates, four kinds of samples in which the coverage of the adhesive 30 to the positive electrode 11 was 0%, 8%, 22%, and 100% were prepared. The coverage of the adhesive 30 when the adhesive 30 is not applied to the positive electrode 11 is 0%, and the coverage of the adhesive 30 when the adhesive 30 is applied to the entire surface of the positive electrode 11 is 100%.

As illustrated in FIG. 14, in the coin cells 110 with the discharge rates of 2 C and 1 C, the discharge capacity retention ratio increased as the coverage of the adhesive 30 increased from 0% to 22%. This is considered to be because the adhesion between the positive electrode 11 and the separator 13 is improved by the coverage of the adhesive 30 being higher than 0%. However, the discharge capacity retention ratio when the coverage of the adhesive 30 was 100% was lower than the discharge capacity retention ratio when the coverage was 22%. This is considered to be because when the coverage of the adhesive 30 is 100%, the entire surface of the positive electrode 11 is covered with the adhesive 30, thereby increasing the resistance.

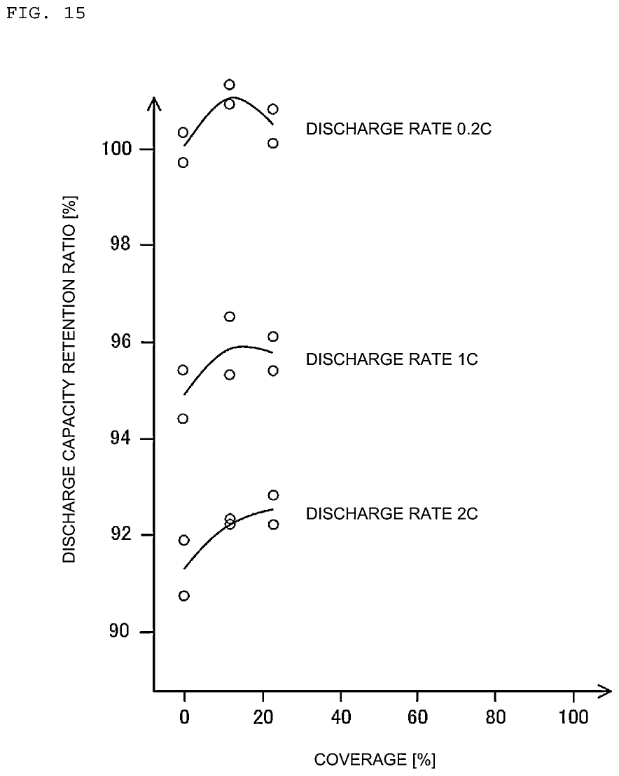

FIG. 15 is a view illustrating a relationship between the coverage of the adhesive 30 to the negative electrode 12 and the discharge capacity retention ratio of the coin cell 110. In this case, the coin cell 110 was discharged at a discharge rate of 0.2 C, 1 C, and 2 C, and the relationship between the coverage of the adhesive 30 to the negative electrode 12 and the discharge capacity retention ratio of the coin cell 110 was examined. For each of the coin cells 110 having different discharge rates, three kinds of samples in which the coverage of the adhesive 30 was 0%, 12%, and 23% were prepared.

As illustrated in FIG. 15, in the coin cells 110 with the discharge rates of 0.2 C, 1 C, and 2 C, the discharge capacity retention ratio was higher in both the case where the coverage of the adhesive 30 was 12% and the case where the coverage was 23% than in the case where the coverage was 0%. This is considered to be because the adhesion between the negative electrode 12 and the separator 13 is improved by the coverage of the adhesive 30 being higher than 0%.

In consideration of the results shown in FIGS. 14 and 15, the coverage of the adhesive 30 to the positive electrode 11 of the secondary battery 100 and the coverage of the adhesive 30 to the negative electrode 12 are each preferably 12% or more and 20% or less. When the coverage of the adhesive 30 to the positive electrode 11 and the coverage of the adhesive 30 to the negative electrode 12 of the secondary battery 100 are each 12% or more and 20% or less, it is possible to suppress deterioration of the battery characteristics due to the presence of the adhesive 30 while maintaining adhesion between the electrode and the separator 13. When the coverage of the adhesive 30 is 12% or more and 20% or less, sufficient adhesiveness as a product can be secured as illustrated in FIG. 12.

The present technology as described herein is not limited thereto and thus can be modified in a suitable manner.

For example, the secondary battery 100 according to an embodiment has a configuration including the stacked body 10 formed by alternately stacking the plurality of positive electrodes 11 and the plurality of negative electrodes 12 with the separator 13 interposed therebetween, and may have a configuration including a wound body including the positive electrode 11, the separator 13, and the negative electrode 12. The wound body has a configuration in which a stacked body of the elongated positive electrode 11 and the elongated negative electrode 12 is wound with the elongated separator 13 interposed therebetween. Also in this wound body, the space between the positive electrode 11 and the separator 13 and the space between the negative electrode 12 and the separator 13 are bonded with the adhesive 30, and the adhesive 30 has a substantially annular shape when viewed in the stacking direction.

The secondary battery and the method of manufacturing the secondary battery in the present application are described below in further detail according to an embodiment.
<1>. A secondary battery including:
a positive electrode;
a negative electrode;
a separator disposed between the positive electrode and the negative electrode; and
an electrolyte,
wherein a space between the positive electrode and the separator and a space between the negative electrode and the separator are bonded with an adhesive, and the adhesive has a substantially annular shape when viewed in a stacking direction of the positive electrode, the separator, and the negative electrode.
<2>. The secondary battery according to <1>, wherein a plurality of the adhesives having the substantially annular shape exist between the positive electrode and the separator and between the negative electrode and the separator, respectively.
<3>. The secondary battery according to <1> or <2>, wherein a coverage of the adhesive to the positive electrode and a coverage of the adhesive to the negative electrode are 12% or more and 20% or less, respectively.
<4>. The secondary battery according to any one of <1> to <3>, wherein the adhesive is not dissolved in the electrolyte.
<5>. A method of manufacturing a secondary battery including:
spraying a suspension containing an adhesive to at least one of a positive electrode and a separator;
spraying the suspension to at least one of a negative electrode and the separator;
evaporating a liquid contained in the sprayed suspension; and
producing a stacked body by stacking the positive electrode, the separator, and the negative electrode in such a way that the separator is interposed between the positive electrode and the negative electrode after the step of evaporating the liquid.
<6>. The method of manufacturing a secondary battery according to <5>, wherein in the step of spraying the suspension, the suspension is sprayed by any one of ultrasonic spraying, two-fluid spraying, and inkjet spraying.
<7>. The method of manufacturing a secondary battery according to <5> or <6>, further including:
accommodating the stacked body inside an exterior body; and
filling the inside of the exterior body with an electrolyte.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode;
a separator disposed between the positive electrode and the negative electrode; and
an electrolyte,
wherein a space between the positive electrode and the separator and a space between the negative electrode and the separator are bonded with an adhesive, and the adhesive has a substantially annular shape when viewed in a stacking direction of the positive electrode, the separator, and the negative electrode.

2. The secondary battery according to claim 1, wherein a plurality of the adhesives having the substantially annular shape exist between the positive electrode and the separator and between the negative electrode and the separator, respectively.

3. The secondary battery according to claim 1, wherein a coverage of the adhesive to the positive electrode and a coverage of the adhesive to the negative electrode are 12% or more and 20% or less, respectively.

4. The secondary battery according to any one of claims 1 to 3, wherein the adhesive is not dissolved in the electrolyte.

5. A method of manufacturing a secondary battery comprising:
spraying a suspension including an adhesive to at least one of a positive electrode and a separator;
spraying the suspension to at least one of a negative electrode and the separator;
evaporating a liquid in the suspension; and
producing a stacked body, including the separator interposed between the positive electrode and the negative electrode, after evaporating the liquid.

6. The method of manufacturing a secondary battery according to claim 5, wherein the suspension is sprayed by any one of ultrasonic spraying, two-fluid spraying, and inkjet spraying.

7. The method of manufacturing a secondary battery according to claim 5, further comprising:
accommodating the stacked body inside an exterior body; and
filling the inside of the exterior body with an electrolyte.
